(19) United States
(12) Patent Application Publication
(10) Pub. No.: US 2006/0239717 A1
(43) Pub. Date: Oct. 26, 2006

(54) Image forming device and image forming method of preventing printing according to a skew of a paper

(76) Inventor: Chul-woo Oh, Suwon-si (KR)

Correspondence Address: STANZIONE & KIM, LLP, 919 18TH STREET, N.W., SUITE 440, WASHINGTON, DC, 20006, US

(21) Appl. No.: 11/371,049

(22) Filed: Mar. 9, 2006

(30) Foreign Application Priority Data
Apr. 26, 2005 (KR) 2005-34400

(51) Int. Cl. G03G 15/08

(52) U.S. Cl. 399/234; 399/235

(57) ABSTRACT

An image forming device has a developing process part comprising a plurality of developing process rollers, and a delivery part to move a printing paper to pass through the developing process part. The image forming device includes a skew sensor to detect a skew degree of the printing paper supplied to the developing process part by the delivery part, a potential forming part to form predetermined potential differences among the plurality of developing process rollers to make a developer be applied on the printing paper, and a controller to prevent the potential forming part from forming the predetermined potential differences on the plurality of process developing rollers when the skew degree of the printing paper deviates from a predetermined allowance range. Thus, the image forming device prevents an image from being formed when the skew degree of the printing paper deviates from the predetermined allowance range.

### CROSS-REFERENCE TO RELATED APPLICATIONS

This application claims the benefit under 35 U.S.C. § 119(a) from Korean Patent Application No. 2005-34400, filed on Apr. 26, 2005 in the Korean Intellectual Property Office, the disclosure of which is incorporated herein in its entirety by reference.

### BACKGROUND OF THE INVENTION

1. Field of the Invention

The present general inventive concept relates to an image forming device and an image forming method, and more particularly, to an image forming device and an image forming method which prevent printing if a printing paper is skewed.

2. Description of the Related Art

Conventionally, an image forming device includes a developing process part having a plurality of developing process rollers, and a delivery part feeding a printing paper to the developing process part. The developing process part selectively applies developer to the printing paper fed by the delivery part, and forms an image on the printing paper.

FIG. 1 is a schematic view illustrating a skew of a printing paper (P) in a conventional image forming device 100. As illustrated therein, the conventional image forming device 100 comprises a developing process part 130 and a delivery part 140. The delivery part 140 delivers the printing paper (P) in a predetermined delivery direction (d). The delivery part 140 supplies the printing paper (P) to the developing process part 130 in a normal state (N) so that a lateral direction of the printing paper (P) is parallel with the predetermined delivery direction (d). The developing process part 130 applies a developer to a predetermined area (A) of the printing paper (P) and then forms an image aligned with the printing paper (P) fed in the normal state (N).

However, the printing paper (P) may be supplied to the developing process part 130 in a tilted state (S) in which the lateral direction of the printing paper (P) are not parallel with the predetermined delivery direction (d) but deviate from the lateral direction due to various disturbances occurring when the delivery part 140 picks up the printing paper (P) abnormally, thereby causing a skew of the printing paper (P).

The developing process part 130 forms the image in the predetermined area (A) both when the printing paper (P) is supplied in the tilted state (S) because the skew is generated during delivery, as well as when the printing paper (P) is supplied in the normal state (N). Therefore, a tilted image is formed on the printing paper (P) even when the printing paper (P) is supplied in the tilted state (S), thereby deteriorating a print quality. When the skew is severe, the image formed on the printing paper (P) is severely tilted, and reprinting the image is required, thereby wasting a developer and the printing paper (P).

### SUMMARY OF THE INVENTION

The present general inventive concept provides an image forming device and an image forming method which prevent printing when a skew degree of a printing paper deviates from an allowance range.

Additional aspects and/or advantages of the present general inventive concept will be set forth in part in the description which follows and, in part, will be obvious from the description, or may be learned by practice of the present general inventive concept.

The foregoing and/or other aspects and advantages of the present general inventive concept may be achieved by providing an image forming device having a developing process part comprising a plurality of developing process rollers, and a delivery part to move a printing paper to pass through the developing process part, the image forming device comprising a skew sensor to detect a skew degree of the printing paper supplied to the developing process part by the delivery part, a potential forming part to form predetermined potential differences among the plurality of developing process rollers to make a developer be applied on the printing paper, and a controller to prevent the potential forming part from forming the predetermined potential differences on the plurality of developing process rollers when the skew of the printing paper deviates from a predetermined allowance range.

The image forming device may further comprise a power source part to supply power to the potential forming part, and a switching part disposed between the power source part and the potential forming part, and the controller comprises a signal generating part to generate an on-signal to close the switching part if the skew degree of the printing paper is within the predetermined allowance range, and an off-signal to open the switching part if the skew degree of the printing paper deviates from the predetermined allowance range.

The image forming device may further comprise an image information supplying part to supply copy image information to the developing process part, wherein the controller comprises a storage part to store the copy image information to be printed if the skew degree of the printing paper deviates from the predetermined allowance range.

The controller may control the delivery part to feed a next printing paper to the developing process part and may supply the copy image information stored in the storage part to the developing process part so that the copy image information to be printed is formed on the next printing paper if the degree skew of the printing paper deviates from the predetermined allowance range.

The foregoing and/or other aspects of the present general inventive concept may also be achieved by providing an image forming method of forming predetermined potential differences among a plurality of developing process rollers to move a developer to a printing paper in a printing forming device, the image forming method comprising feeding the printing paper to a developing process part having a plurality of developing process rollers, sensing a skew degree of the printing paper, removing the predetermined potential differences formed among the plurality of developing process rollers if the skew degree of the printing paper deviates from a predetermined allowance range, and receiving the printing paper from the developing process part without applying developer.

The image forming method may further comprise supplying copy image information to the developing process part, and storing the copy image information to be printed if the skew degree of the printing paper deviates from the predetermined allowance range.

The foregoing and/or other aspects of the present general inventive concept may also be achieved by providing an image forming apparatus to print an image on a recording medium, the image forming apparatus comprising a developing process part to form an image on a recording medium using a potential, an alignment sensor to determine whether the recording medium is aligned with a reference line, and a controller to adjust the potential of the developing process part to prevent the image from being formed on the recording medium according to the alignment sensor determination of whether that the recording medium is aligned with the reference line.

The foregoing and/or other aspects of the present general inventive concept may also be achieved by providing a method for an image forming apparatus, the method comprising forming an image on a recording medium using a potential, determining whether the recording medium is aligned with a reference line, and adjusting the potential to prevent image from being formed on the recording medium according to the determination of whether the recording medium is aligned with the reference line.

The foregoing and/or other aspects of the present general inventive concept may also be achieved by providing a method for an image forming apparatus, the method comprising determining whether a recording medium is substantially aligned with a direction, applying a developer in an image area of the recording medium when the recording medium is substantially aligned with a direction, and preventing the developer to reach the recording medium when the recording medium is not substantially aligned with the direction.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view illustrating a skewed printing paper in a conventional image forming device;

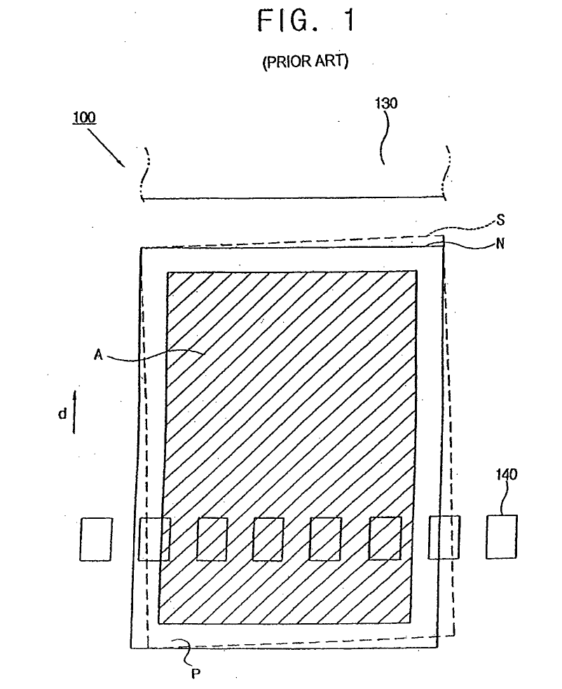

FIG. 2 is a block view illustrating an image forming device according to an embodiment of the general inventive concept;

FIG. 3 is a schematic view illustrating a developing process part of the image forming device of FIG. 2; and

FIG. 4 is a flow chart illustrating an image forming process according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

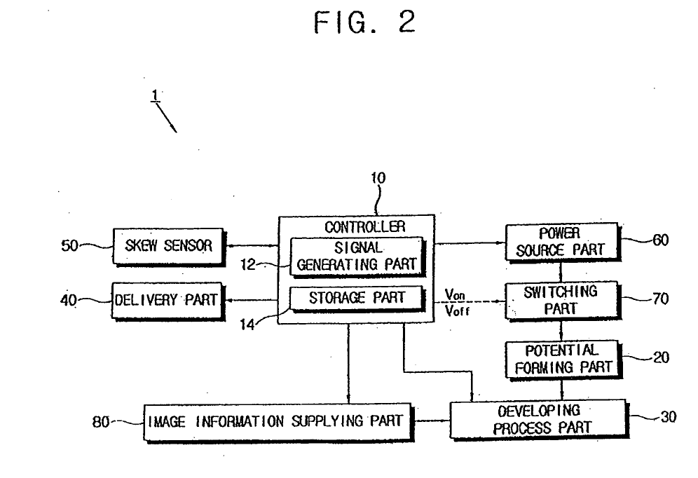

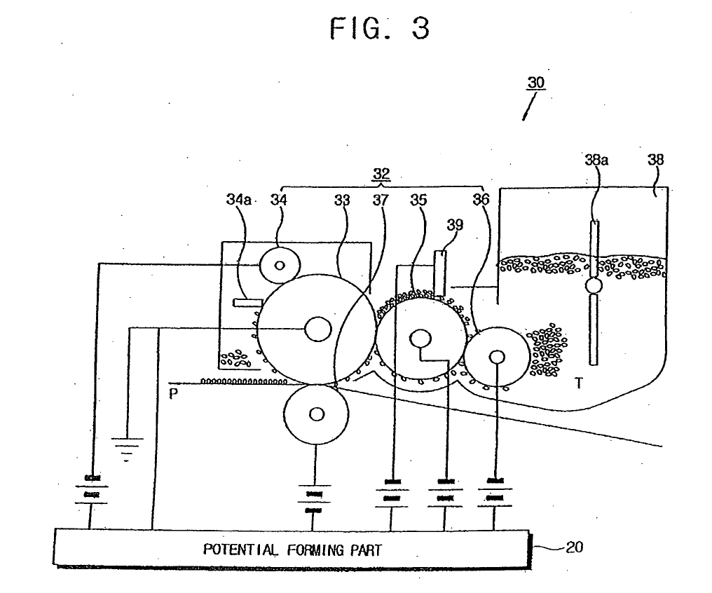

FIG. 2 is a block view illustrating an image forming device 1 according to an embodiment of the present general inventive concept, and FIG. 3 is a schematic view illustrating a developing process part 30 of the image forming device 1 of FIG. 2. Referring to FIGS. 2 and 3, the image forming device 1 comprises the developing process part 30, a potential forming part 20, a delivery part 40, a skew sensor 50, and a controller 10. The potential forming part 20 and the developing process part 30 may constitute an image forming unit to form an image on a recording medium using toner or ink.

The developing process part 30 comprises a plurality of developing process rollers 32, and applies a developer (T) to form an image on the recording medium, such as a printing paper (P). The developing process rollers 32 include an organic photo conductor (OPC) 33, a developing roller 35, a transferring roller 37, a charging roller 34 and a supplying roller 36. The OPC 33 rotates in contact with the developing roller 35, the transferring roller 37, and the charging roller 34.

The OPC 33 receives light emitted by a light emitting unit (not shown) to form an electrostatic latent image. The developing roller 35 applies the developer (T) to the electrostatic latent image formed on the OPC 33, so that the developer adheres to the OPC. The transferring roller 37 transfers the developer (T) from the OPC 33 to the printing paper (P) which is moved between the OPC 33 and the transferring roller 37 by the delivery part 40. A cleaning part 34a removes a residue developer, which remains on the OPC 33 after the developer (T) is transferred from the OPC 33 on the printing paper (P). The charging roller 34 removes electric charges from the OPC 33 to make the OPC 33 have a uniform potential.

A developer storage part 38 stores the developer (T), and the supplying roller 36 receives the developer (T) from the developer storage part 38 and then supplies the received developer (T) to the developing roller 35. An agitator 38a mixes and delivers the developer (T) inside the developer storage part 38 so that the developer (T) is moved to the supplying roller 36. A doctor blade 39 controls an amount of the developer (T) supplied by the developing roller 35 to the OPC 33. The OPC 33, the developing roller 35, the supplying roller 36, the transferring roller 37, the charging roller 34, and the agitator 38a are rotated by a driving part (not shown).

The potential forming part 20 forms predetermined potential differences among the plurality of developing process rollers 32 to move the developer (T) to be applied to the printing paper (P). If a power source part 60 supplies power to the potential forming part 20, the potential forming part 20 transforms the power of a voltage and distributes the transformed power. Therefore, the potential forming part 20 makes the OPC 33, the developing roller 35, the supplying roller 36, the transferring roller 37, and the charging roller 34 respectively have predetermined potentials different from one another, that is, there are the predetermined potential differences among the plurality of developing process rollers 32.

The potential forming part 20 supplies the predetermined potentials to the corresponding developing process rollers 32, so that the developer (T) is moved from the supplying roller 36 to the developing roller 35 and then from the developing roller 35 to the OPC 33 due to the predetermined potential differences. Finally, the developer (T) is applied to the printing paper (P) from the OPC 33. Further, the charging roller 34 removes the electric charges from the OPC 33. The doctor blade 39 controls the amount of the developer on the developing roller 35.

The delivery part 40 moves the printing paper (P) to pass through the developing process part 30. The delivery part 40 feeds the printing paper (P) to the developing process part 30 so that the printing paper (P) moves between the OPC 33 and the transferring roller 37. The delivery part 40 receives the printing paper (P) from the developing process part 30 and delivers the printing paper (P) to a fixing unit (not shown). The fixing unit (not shown) makes the developer (T) applied to the printing paper (P) be fixed to the printing paper (P).

The delivery part 40 receives the printing paper (P) from the developing process part 30 and delivers the printing paper (P) to the fixing unit regardless of whether the developing process part 30 applies the developer (T) to the printing paper (P). When the printing paper (P) is normally fed to the developing process part 30, the delivery part 40 receives the printing paper (P) after the developing process part 30 applies the developer (T). When the printing paper (P) is fed skewed, and a skew degree deviates from a predetermined allowance range, the delivery part 40 makes the printing paper (P) pass through the developing process part 30, while the developing process part 30 does not apply the developer (T).

The skew sensor 50 senses the skew of the printing paper (P) which is fed to the developing process part 30 by the delivery part 40. The skew sensor 50 senses the skew (slant) degree of the printing paper (P), which is fed to the developing process part 30, and sends the skew degree to the controller 10. The skew sensor 50 may sense the skew degree by detecting a distance along an entering direction between edges of a front end of the printing paper (P), which enters the developing process part 30 (a top skew). Further, the skew sensor 50 may sense the skew degree by detecting a distance along a transverse direction that is perpendicular to the entering direction, by detecting a distance between edges of a lateral side of the printing paper (P), which enters the developing process part 30 (a side skew). The skew sensor 50 may use a conventional unit sensing the skew of the printing paper (P), such as a contact image sensor (CIS), a charge coupled device (CCD), etc. According to an embodiment of the present inventive concept, the skew sensor 50 may be an alignment sensor to detect a state of the printing paper (P) or the recording medium with respect to a reference line, along which the printing paper or recording medium (P) is fed, to determine the skew degree, for example, an alignment degree determined when the printing paper (P) is not aligned with the reference line. It is possible that the skew sensor 50 detects the skew degree according to the state of the edges or lateral side of the printing paper P with respect to the reference line. For example, when a skew portion of the edges of the printing paper (P) is not perpendicular to the reference line, or when a skew portion of the lateral side of the printing medium is not parallel to the reference line, it is determined that the paper skew occurs according to a distance between the skew portion and a non-skew portion of the printing paper (P).

The controller 10 compares the skew degree of the printing paper (P), which is received from the skew sensor 50, to the predetermined allowance range. If the skew degree of the printing paper (P) deviates from the predetermined allowance range, the controller 10 prevents the potential forming part 20 from forming the predetermined potential differences among the plurality of developing process rollers 32 of the developing process part 30, so that the developer (T) is not applied to the printing paper (P). Here, the delivery part 40 receives the printing paper (P), and delivers the received printing paper (P) to the developing process part 30 that does not apply the developer (T). In contrast, if the skew degree of the printing paper (P) is within the predetermined allowance range, the controller 10 controls the potential forming part 20 to form the predetermined potential differences on the corresponding developing process rollers 32 of the developing process part 30, so that the developer (T) is applied to the printing paper (P). The predetermined allowance range may be already stored in the controller 10 or may be input through a user interface (not shown) by a user.

The controller 10 includes a signal generating part 12 which generates a signal for turning on/off a switching part 70. The controller 10 turns on/off the switching part 70 according to the signal generated by the signal generating part 12, and then controls the potential forming part 20 to form the predetermined potential differences. If the skew degree of the printing paper (P) is within the predetermined allowance range, the signal generating part 12 generates an on-signal (Von), and if the skew degree of the printing paper (P) is not within the predetermined allowance range, the signal generating part 12 generates an off-signal (Voff). The signal generating part 12 may generate the on-signal (Von) and the off-signal (Voff) having different voltages from each other. Alternatively, the signal generating part 12 may generate the on-signal and the off-signal having different currents from each other. Other types of different signals may be used as the on-signal (Von) and the off-signal (Voff).

The switching part 70 electrically connects the power source part 60 and the potential forming part 20. If the switching part 70 receives the on-signal (Von) from the signal generating part 12, the switching part 70 connects the power source part 60 with the potential forming part 20 so that the power is supplied to the potential forming part 20. Accordingly, the potential forming part 20 transforms the power and distributes the transformed power to form the predetermined potentials corresponding to each of the developing process rollers 32. If the switching part 70 receives the off-signal (Voff) from the signal generating part 12, the switching part 70 disconnects the power source part 60 from the potential forming part 20 so that then the power is not supplied to the potential forming part 20.

The switching part 70 may be a conventional electric circuit, which is a closed circuit or an open circuit according to the input signal. As long as the switching part 70 prevents the potential forming part 20 from forming the predetermined potentials at the developing process rollers 32, the switching part 70 may be placed between the potential forming part 20 and the developing process part 30 or may be placed inside the potential forming part 20 or developing process part 30.

An image information supplying part 80 supplies copy image information to the developing process part 30. The developing process part 30 forms a copy image on the printing paper (P) according to the copy image information supplied from the image information supplying part 80. The image information supplying part 80 may be an external computer (not shown) or an image processor which receives data from the external computer and translates the data into the copy image information. Further, the image information supplying part 80 may be a storage unit (not shown) to store the copy image information.

The controller 10 comprises a storage part 14 to store the copy image information supplied from the image information supplying part 80. The controller 10 stores the copy image information in the storage part 14 if the skew degree of the printing paper (P) deviates from the predetermined allowance range. Then, the controller 10 makes the delivery part 40 to feed a next printing paper (P) to the developing process part 30 and supplies the copy image information stored in the storage part 14 to the developing process part 30. At this moment, the skew sensor 50 senses the skew degree of the next printing paper (P) which is supplied to the developing process part 30. If the skew degree of the next printing paper (P) deviates from the predetermined allowance range, the controller 10 prevents the potential forming part 20 from forming the predetermined potentials and then stores again the copy image information in the storage part 14. If the skew degree of the next printing paper (P) is within the predetermined allowance range, the controller 10 controls the potential forming part 20 to form the predetermined potentials and provides the copy image information to the developing process part so that the copy image is printed on the next printing paper (P).

Accordingly, if the skew degree of the printing paper (P) deviates from the predetermined allowance range, the signal generating part 12 generates the off-signal (Voff) to make the switching part 70 disconnect the power source part 60 from the potential forming part 20, so that the copy image is not formed on the printing paper (P). Meanwhile, the corresponding copy image information, is stored and supplied to the developing process part 30, thereby printing the copy image, when the skew degree of the printing paper (P) is within the predetermined allowance range.

If the skew degree of the printing paper deviates from the predetermined allowance range, the delivery part 40 may again feed the printing paper (P), which is received from the developing process part 30 in a state in which the developer (T) is not applied, to the developing process part 30.

The image forming device 1 may have an output part (not shown), and the controller 10 can display a message representing that the copy image is not formed through the output part (not shown) when the skew degree deviates from the predetermined allowance range.

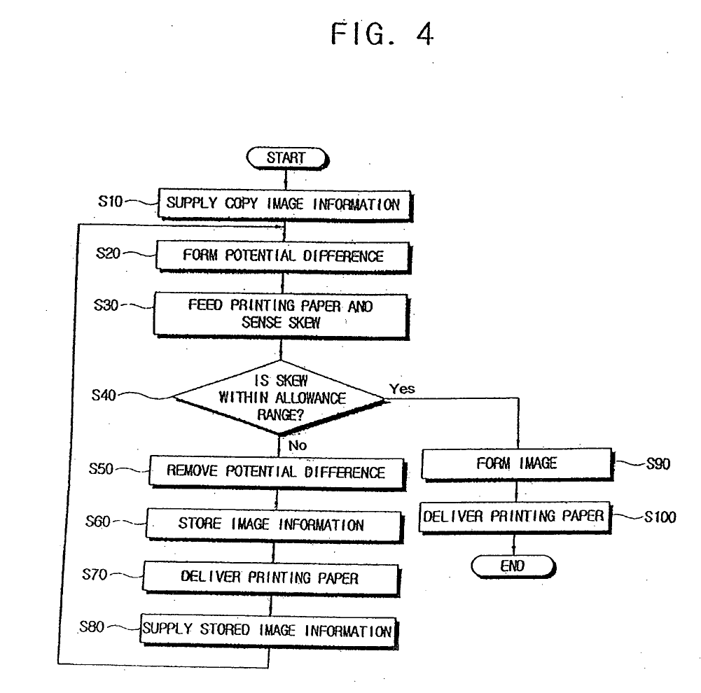

FIG. 4 is a flow chart illustrating an image forming process according to an embodiment of the present general inventive concept. Referring to FIG. 4, at operation S10, copy image information is supplied to a developing process part having developing process rollers, and at operation S20, predetermined potential differences are formed among the developing process rollers so that a developer is moved from a developer storage part to an OPC. The supplying of the copy image information, operation S10, and the forming of the predetermined potential differences, operation S20, may be sequentially in an order or a reverse order or simultaneously performed.

Next, at operation S30, a printing paper is fed to the developing process part, and a skew degree of the printing paper is sensed. At operation S40, the skew degree of the printing paper is compared to a predetermined allowance range. At operation S50, the predetermined potential differences formed among the developing process rollers are removed if the skew degree of the printing paper deviates from the predetermined allowance range. Therefore, the developer is not transferred among the developing process rollers, thereby preventing the developer from being applied to the printing paper. At operation S60, the copy image information is stored when a copy image corresponding to the copy image information is not printed due to the skew of the printing paper, and at operation S70, the printing paper, on which the developer has not been applied, is received from the developing process part and is delivered to a fixing unit. The storing of the copy image information, operation S60 and the delivering of the printing paper, operation S70 may be in an order or a reversed order or simultaneously accomplished. At operation S80, the stored copy image information is supplied to the developing process part, and the forming of the predetermined potential differences, operation S20 and the feeding of the printing paper, operation S30 are repeated, thereby printing the copy image which has not been printed because of the skew.

At operation S40, the skew degree of the printing paper is detected, and when the skew degree is within the predetermined allowance range, at operation S90, the image is formed on the printing paper, and at operation S100, the printing paper with the image is received from the developing process and is delivered to the fixing unit, thereby finishing the image forming process.

The image forming process according to the embodiment of the present general inventive concept may form the copy image on a single printing paper or on a plurality of printing papers. When the copy image is formed on the plurality of printing papers, the present embodiment may repeatedly perform the operations from the supplying of the copy image information, operation S10 to the delivering of the printing paper, operation S100.

Although a few embodiments of the general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming device having a developing process part comprising a plurality of developing process rollers, and a delivery part to move a printing paper to pass through the developing process part, the image forming device comprising:
a skew sensor to detect a skew degree of the printing paper supplied to the developing process part by the delivery part;
a potential forming part to form predetermined potential differences among the plurality of developing process rollers to make a developer be applied on the printing paper; and
a controller to prevent the potential forming part from forming the predetermined potential differences on the plurality of process developing rollers when the skew degree of the printing paper deviates from a predetermined allowance range.

2. The image forming device according to claim 1, further comprising:
a power source part to supply power to the potential forming part; and
a switching part disposed between the power source part and the potential forming part; and
wherein the controller comprises a signal generating part to generate an on-signal to close the switching part if the skew degree of the printing paper is within the predetermined allowance range, and an off-signal to open the switching part if the skew degree of the printing paper deviates from the predetermined allowance range.

3. The image forming device according to claim 2, further comprising:
an image information supplying part to supply copy image information to the developing process part,
wherein the controller comprises a storage part to store the copy image information to be printed if the skew degree of the printing paper deviates from the predetermined allowance range.

4. The image forming device according to claim 3, wherein the controller controls the delivery part to feed a next printing paper to the developing process part and supplies the copy image information stored in the storage part to the developing process part so that the copy image information to be printed is formed on the next printing paper if the skew degree of the printing paper deviates from the predetermined allowance range.

5. An image forming method of forming predetermined potential differences among a plurality of developing process rollers to move a developer to a printing paper in an image forming device, the image forming method comprising:
feeding the printing paper to a developing process part having a plurality of developing process rollers;
sensing a skew degree of the printing paper;
removing the predetermined potential differences formed among the plurality of developing process rollers if the skew degree of the printing paper deviates from a predetermined allowance range; and
receiving and delivering the printing paper from the developing process part without applying developer.

6. The image forming method according to claim 5, further comprising:
supplying copy image information to the developing process part; and
storing the copy image information to be printed if the skew degree of the printing paper deviates from the predetermined allowance range.

7. An image forming apparatus to print an image on a recording medium, the image forming apparatus comprising:
a developing process part to form an image on a recording medium using a potential;
an alignment sensor to determine whether the recording medium is aligned with a reference line; and
a controller to adjust the potential of the developing process part to prevent the image from being formed on the recording medium according to the determination of whether the recording medium is aligned with the reference line.

8. The image apparatus according to claim 7, wherein the alignment sensor detects a skew degree of the recording medium with respect to the reference line, and the controller determines that the recording medium is not aligned with the reference line if the skew degree is outside a predetermined range.

9. The image forming apparatus according to claim 8, wherein the alignment sensor detects the skew degree by measuring a distance along the reference line between edges of the recording medium substantially perpendicular to the reference line.

10. The image forming apparatus according to claim 8, wherein the alignment sensor detects the skew degree by measuring a distance along a direction perpendicular to the reference line between edges of the recording medium substantially parallel to the reference line.

11. The image forming apparatus according to claim 7, further comprising:
a potential forming part to supply the potential to the developing process part if the recording medium is aligned with the reference line,
wherein the developing process part comprises a plurality of developing process rollers, and the potential forming part supplies the potential to the plurality of developing process rollers.

12. The image forming apparatus according to claim 11, wherein the potential comprises a plurality of potential differences, and the controller controls the potential forming part not to supply at least one of the potential differences to the corresponding one of the developing rollers according to the determination of whether the recording medium is aligned with the reference line.

13. The image forming apparatus according to claim 12, further comprising:
a power supply connected to the potential forming part to provide an electric power to the potential forming part,
wherein the potential forming part transforms the electric power received from the power supply into the potential differences.

14. The image forming apparatus according to claim 13, further comprising:
a switching unit connected between the power supply and the potential forming part to connect the power supply and the potential forming part when the recording medium is aligned with the reference line, and to disconnect the power supply from the potential forming part when the recording medium is not aligned with the reference line.

15. The image forming apparatus according to claim 14, wherein the controller generates an on-signal provided to the switching unit to connect the power supply and the potential forming part, and the controller generates an off-signal provided to the switching unit to disconnect the power supply from the potential forming part.

16. The image forming apparatus according to claim 7, wherein the controller displays a message when the recording medium is not aligned with the reference line.

17. The image forming apparatus according to claim 7, wherein the controller comprises a storage unit to store information on the image when the recording medium is not aligned with the reference line.

18. The image forming apparatus according to claim 7, further comprising:
a storage unit to store information on the image when the image has not been formed on the recording medium according to the determination,
wherein the alignment sensor determines whether a next recording medium is aligned with the reference line, and the controller prints the image on the next recording medium using the stored information.

19. The image forming apparatus according to claim 18, further comprising:
a delivery part to deliver the recording medium and the next recording medium,
wherein the alignment sensor is disposed in the delivery part.

20. The image forming apparatus according to claim 7, further comprising:
a developer supply unit to transfer a developer within the developing process part to form the image when the recording medium is aligned with respect to the reference line,
wherein the developer supply unit does not transfer the developer according to the adjustment of the potential.

21. A method of an image forming apparatus, the method comprising:
determining whether a recording medium is substantially aligned with a direction;
applying a developer in an image area of the recording medium when the recording medium is substantially aligned with a direction; and
preventing the developer to reach the recording medium when the recording medium is not substantially aligned with the direction.

22. The method according to claim 21, further comprising:
providing a next recording medium when the recording medium is not substantially aligned with the direction;
determining whether the next recording medium is substantially aligned with the direction;
applying the developer in an image area of the next recording medium when the next recording medium is substantially aligned with the direction; and
preventing the developer to reach the next recording medium when the next recording medium is not substantially aligned with the direction.
